(19) United States
(12) Patent Application Publication
(10) Pub. No.: US 2024/0232591 A1
(43) Pub. Date: Jul. 11, 2024

(54) OVERCOMING TECHNICAL CHALLANGES OF WORKING IN A VERY HIGH DIMENSIONAL SPACE

(71) Applicant: AUTOBRAINS TECHNOLOGIES LTD, Tel Aviv-Yafo (IL)

(72) Inventors: Lior BLECH, TEL AVIV (IL); Igal Raichelgauz, Tel Aviv (IL)

(73) Assignee: AUTOBRAINS TECHNOLOGIES LTD, Tel Aviv-Yafo (IL)

(21) Appl. No.: 18/405,500

(22) Filed: Jan. 5, 2024

Related U.S. Application Data
(60) Provisional application No. 63/478,692, filed on Jan. 5, 2023.

(51) Int. Cl. G06N 3/0495

(52) U.S. Cl. CPC G06N 3/0495

(57) ABSTRACT

A method for generating a sparse representation of a group of neural network features, the method includes (i) obtaining a group of neural network features (NNFs); and (ii) generating a lossless and sparse representation of the group of NNF, wherein the generating includes: (a) determining, by an allocation unit and based on one or more attributes of the group of NNFs, one or more relevant sparse representation generators (SRGs) out of a set of SRGs; (b) generating, by the one or more relevant SRGs, one or more relevant sparse outputs; (c) processing the one or more relevant sparse outputs to provide the lossless and sparse representation of the group of NNFs; and (d) outputting the lossless and sparse representation of the group of NNFs.

### BACKGROUND

Neural network may be arranged to output feature maps of relatively limited dimensionality.

Working in a very high dimensional space (for example—having more than 1000, or even more than 10,000 dimensions) may be beneficial when a high dimensional sparse representation is sparse. A sparsity may enable, under certain conditions, to compress the representation while distinguishing between one sparse representation to the other.

On the other hand, working in the very high dimensional space may require an extensive amount of computational and/or memory resources.

There is a growing need to provide a solution for expanding the dimensions of feature maps generated by neural network, in a resource efficient manner.

### BRIEF DESCRIPTION OF THE DRAWINGS

The embodiments of the disclosure will be understood and appreciated more fully from the following detailed description, taken in conjunction with the drawings in which:

FIG. 1 illustrates an example of a method;

FIG. 2 illustrates an example of a system;

FIG. 3 illustrates an example of outputs;

FIG. 4 illustrates an example of a system;

FIG. 5 illustrates an example of a training process;

FIG. 6 illustrates an example of a training process; and

FIG. 7 illustrates an example of a system.

### DESCRIPTION OF EXAMPLE EMBODIMENTS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a device or system capable of executing the method and/or to a non-transitory computer readable medium that stores instructions for executing the method.

Any reference in the specification to a system or device should be applied mutatis mutandis to a method that may be executed by the system, and/or may be applied mutatis mutandis to non-transitory computer readable medium that stores instructions executable by the system.

Any reference in the specification to a non-transitory computer readable medium should be applied mutatis mutandis to a device or system capable of executing instructions stored in the non-transitory computer readable medium and/or may be applied mutatis mutandis to a method for executing the instructions.

Any combination of any module or unit listed in any of the figures, any part of the specification and/or any claims may be provided.

Any one of the perception unit, narrow AI agents, MI evaluation unit may be implemented in hardware and/or code, instructions and/or commands stored in a non-transitory computer readable medium, may be included in a vehicle, outside a vehicle, in a mobile device, in a server, and the like.

The vehicle may be any type of vehicle that a ground transportation vehicle, an airborne vehicle, and a water vessel.

The specification and/or drawings may refer to an image. An image is an example a sensed information unit (SIU). Any reference to an image may be applied mutatis mutandis to any other type of sensed information units such as a natural signal such as but not limited to signal generated by nature, signal representing human behavior, signal representing operations related to the stock market, a medical signal, financial series, geodetic signals, geophysical, chemical, molecular, textual and numerical signals, time series, a sensed information unit of any kind, a sensed information unit that is sensed by any type of sensors—such as a visual light camera, an audio sensor, a sensor that may sense infrared, radar imagery, ultrasound, electro-optics, radiography, LIDAR (light detection and ranging), etc. The sensing may include generating samples (for example, pixel, audio signals) that represent the signal that was transmitted, or otherwise reach the sensor.

The specification and/or drawings may refer to a concept structure. A concept structure may include one or more clusters. Each cluster may include signatures and related metadata. Each reference to one or more clusters may be applicable to a reference to a concept structure.

The specification and/or drawings may refer to a processor. The processor may be a processing circuitry. The processing circuitry may be implemented as a central processing unit (CPU), and/or one or more other integrated circuits such as application-specific integrated circuits (ASICs), field programmable gate arrays (FPGAs), full-custom integrated circuits, etc., or a combination of such integrated circuits.

Any combination of any steps of any method illustrated in the specification and/or drawings may be provided.

Any combination of any subject matter of any of claims may be provided.

Any combinations of systems, units, components, processors, sensors, illustrated in the specification and/or drawings may be provided.

Any reference to an object may be applicable to a pattern. Accordingly—any reference to object detection is applicable mutatis mutandis to a pattern detection.

A key challenge in constructing the Sparse Binary Readout is the high dimensionality of the spaces needed and the consequent high computational complexity of the readout.

Given a keypoint dimension of N and output SBR dimension M, the complexity of the operation is O(NM), with a corresponding memory requirement for weights of the same order. Since the result of the operation is sparse, we expect to be able to reduce the computational cost with no noticeable hit on performance, which in turn enables increasing the dimensionality and further performance gains. Overcoming this challenge is done through the concept of routing, which includes solving a task by dividing work, where each neural network typically specializes in a different aspect of the task or a subspace of the data.

The solution may use routing that involves selecting relevant sparse representation generators (SRGs) or irrelevant SRGs.

An SRG receives an input and returns its output, or does not and is assumed to output a zero vector. The overall result is the combination of the individual outputs—for example as their concatenation.

In some cases the output of the router can be used to construct a compressed version of the output which is easier to store, such as the case where the output is limited to a one hot vector.

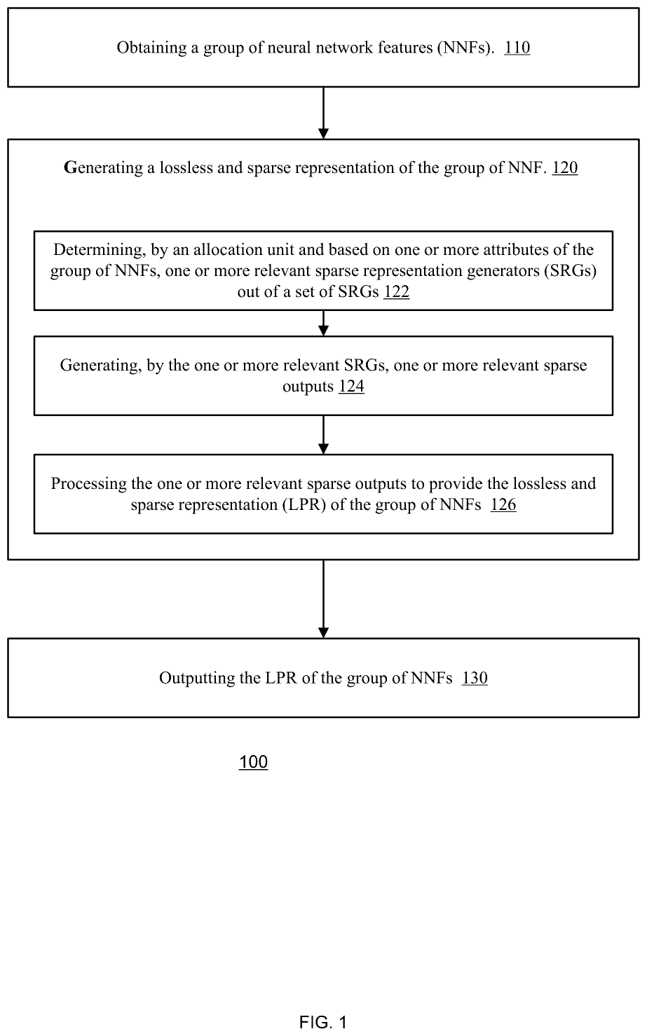

In this case it is sufficient to output the routing bits of the router in conjunction with the output of the single network which was activated. The structure of a system that includes the router is illustrated in FIG. 1.

Given D participating SRGs, the complexity of the router is O(ND). Each individual SRG can be set up to output a subspace of dimension (M/D), so its computational complexity is O(NM/D). Since we only need to compute a small subset of the neural networks according to the output of the router this amount to an overall complexity of O(ND+(NM/D)). Minimizing this expression with respect shows that the minimum complexity achievable is O(N*SQUARE(M)), at D˜SQUARE(M), assuming this number of participants is optimal with respect to performance on the task as well

Using a hierarchy of SRGs (tree structure) reduces the complexity to O(nNM^{1/n}) where n is the depth of the tree structure. Optimizing n to reduce complexity shows the overall complexity of the hierarchical router is O(NlogM), which is much smaller than the unit depth version for large M.

According to an embodiment, the NN is used for driving related applications—for example for impacting the navigation of an autonomous vehicle, impacting ADAS (advance driver assistance system) decisions, and the like. According to an embodiment, the NN may participate in detecting objects or scenarios, in performing driving related operations (setting the direction of progress, estimating future progress, determining the speed and/or acceleration of the vehicle), and the like.

According to an embodiment, the NN is used for application that are not related to driving.

According to an embodiment, the NN is fed by a SIU. According to an embodiment an NN feature represents content included in a sensed information unit, or in a part of a sensed information unit (for example one pixel or multiple pixels of the sensed information unit.

According to an embodiment, the content represented by a NN feature is indicative of an object, a part of an object, a scenario, a part of a scenario, or any other perception or contextual element captured in the sensed information unit or included in additional information such as traffic rules.

According to an embodiment, the content represented by a NN feature is more abstract than an NN features that is directly indicative of an object, as different layers of the NN exhibit different abstraction levels. The same applies to a sparse representation of such NN feature. For example a NN feature may be indicative of edges of basic shapes within the image—while NN features of more downstream layers may provide more information about specific objects.

According to an embodiment, a sparse representation of a group of NN features provides a representation of content included in a sensed information unit, in a group of sensed information units, in a part of a sensed information unit, in a group of parts of the sensed information unit (for example one pixel, a group of pixels, multiple pixels or a group of pixels of the sensed information unit) or in a group of parts of a group of sensed information units.

According to an embodiment, the content represented by a sparse representation of a group of NN features is indicative of an object, a group of objects, a part of an object, a group of parts of one or more objects, a scenario, a part of a scenario, a group of scenarios, a group of parts of one or more scenarios, or any one or more other perception or contextual element captured in the sensed information unit or included in additional information such as traffic rules.

FIG. 1 illustrates a method 100 for generating a sparse representation of a group of neural network (NN) features.

The NN features may be outputted from a single layer of the NN (for example may be a feature map) or may be outputted from multiple layers of the NN.

Method 100 may start by step 110 of obtaining a group of neural network features (NNFs). The group of NNFs includes a first number (N1) of NNF elements. The first number may range between 10 and 100, between 5 and 500, between 20 and 1000, and the like.

Step 110 may include retrieving the group of NNF from the NN or from a memory unit that stores the NNF. Alternatively, step 110 may include generating the group of NNF by the NN.

Step 110 may be followed by step 120 of generating a lossless and sparse representation of the group of NNF.

Step 120 may include a sequence of steps that includes step 122, step 124 and step 126.

Step 122 may include determining, by an allocation unit and based on one or more attributes of the group of NNFs, one or more relevant sparse representation generators (SRGs) out of a set of SRGs.

The allocation unit may be a router or nay other unit capable of allocation of processing to different SRGs. A router determines to which SRGs are relevant and sends the group of NNFs to the relevant SRGs.

The different SRGs of the set may be associated with different situations. What amount to situation may be determined in advance (explicit determination) or may be determined during a learning process (implicit determination). A combination of explicit determination and implicit determination may be provided—some of the situations may be predefined and some are learnt.

The advantage of using explicit determination lies in the early subdivision of the situations, which alleviates the difficulties of implicit determination, and allows using a variety of classical methods that take advantage of known structure in the data where it is known in advance. The disadvantage of explicit determination, is the lack of adaptability of the algorithms, and thus their possible lack of robustness and reliance on human guidance to choose algorithms and parameters, as well as the relative difficulty of incorporating new knowledge and data into an existing system and retraining. The implicit determination, by choosing the subdivision as part of their training procedure, allow for greater potential robustness, adaptability and do not require as much supervision. The disadvantage of the implicit determination is their relative difficulty of implementation, which we now address.

Step 124 may include generating, by the one or more relevant SRGs, one or more relevant sparse outputs. For example—one or more sparse binary representation segments.

Step 126 may include processing the one or more relevant sparse outputs to provide the lossless and sparse representation (LPR) of the group of NNFs.

The LPR of the group of NNFs may consist of may consist essentially of one or more outputs of the one or more relevant SRGs and SRG indicators that identify the one or more relevant SRGs.

The SRG indicators are routing bits. The routing bits indicate which SRGs pf the set are the relevant SRGs.

Step 120 may be followed by step 130 of outputting the LPR of the group of NNFs. Step 130 may include storing the LPR of the group of NNFs in a memory unit, transmitting the LPR of the group of NNFs, and the like. The LPR of the group of NNFs is stored in a manner that allows a retrieval of the LPR of the group of NNFs for further processing.

The processing may include concatenating two or more relevant sparse outputs.

The processing may include omitting outputs (if such exist) of irrelevant SRGs—or setting outputs of irrelevant SRGs to be equal an irrelevancy indictor. The processing may include adding or otherwise sending any selection bits.

The LSR of the group of NNFs may include one or more outputs of the one or more relevant SRGs and does not include any output of an irrelevant SRG.

The LSR of the group of NNFs may include one or more outputs of the one or more relevant SRGs and one or more outputs of one or more irrelevant SRG.

The a value of an output of an irrelevant SRG may be indicative that the output was generated by an irrelevant SRG. For example—the value may be a unique value that is associated with an irrelevant SRG indicator.

The SRGs of the set of SRGs may be arranged in a hierarchical manner—in multiple levels/layers.

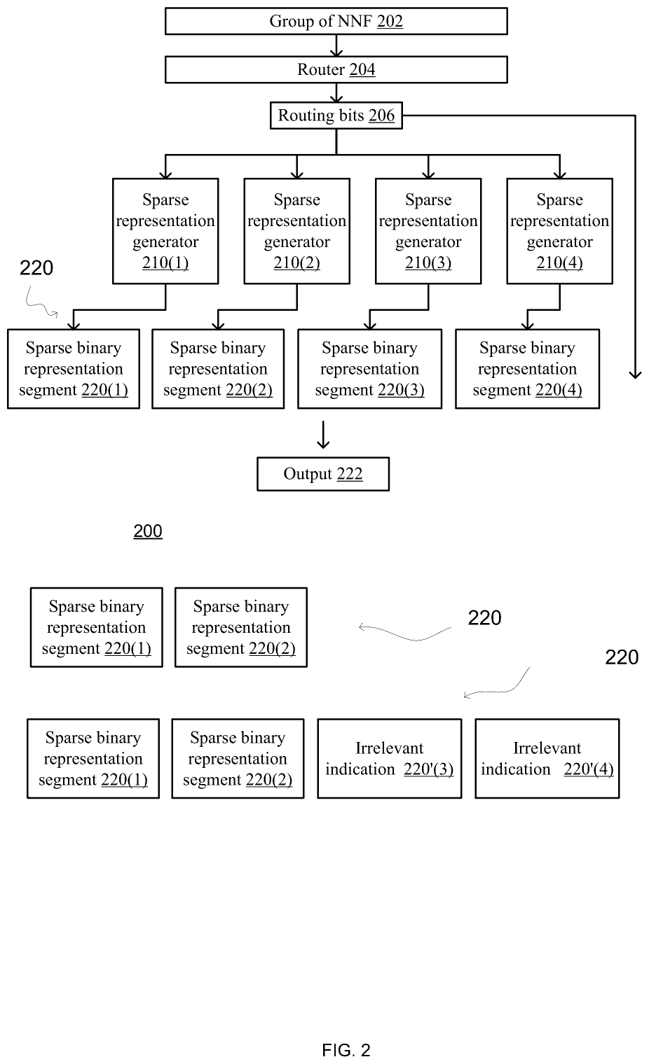

FIG. 2 illustrates an example of a system 200 that include a router 204 and a set of four SRGs (210(1)-210(2), 210(3) and 210(4)). There may be any number of SRGs—two, three, more than four, and the like.

The router 204 receives a group of NNFs 202 and determines which SRGs of the set is relevant—and outputs routing bits 206 that indicate which SRG is relevant.

The relevant SRGs output relevant sparse outputs such as sparse binary representation segments (SBRSs).

At least some of the sparse binary representation segments and maybe the routing bits may be included in an output 200 of the system.

The upper part of FIG. 2 illustrates that all four SRGs output SBRSs—but this is not necessarily so—for example—only relevant SRGs may output SBRSs.

For example—FIG. 2 also illustrates in which the third and fourth SRGs are irrelevant—and only the first and second SRGs output their SBRSs. In this case the routing bits should be included in the output 222—to indicate that the SBRSs are outputted by the first and second SRGs.

FIG. 2 also illustrates an example in which the third and fourth SRGs are irrelevant—and they outputs SBRSs that include irrelevant indications 220′(3) and 220′(4). BRSs

The number of relevant SRGs may include one or more SEGs.

Sending only the outputs of relevant SRGs saves energy and saves communication and storage resources.

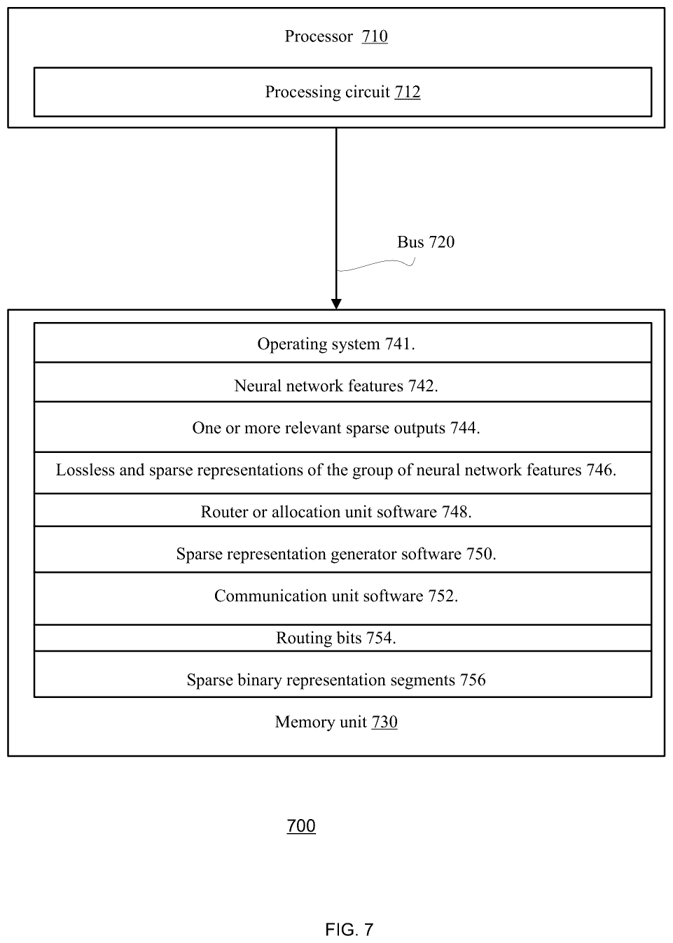

According to an embodiment, the router and any of the SEGs are implemented by a system (for example system 700 of FIG. 7) that includes one or more processors, each including one or more processing circuits. The system may include communication units and/or one or more busses for communication between the one or more processors and/or one or more memory units—some of which also belong to the system.

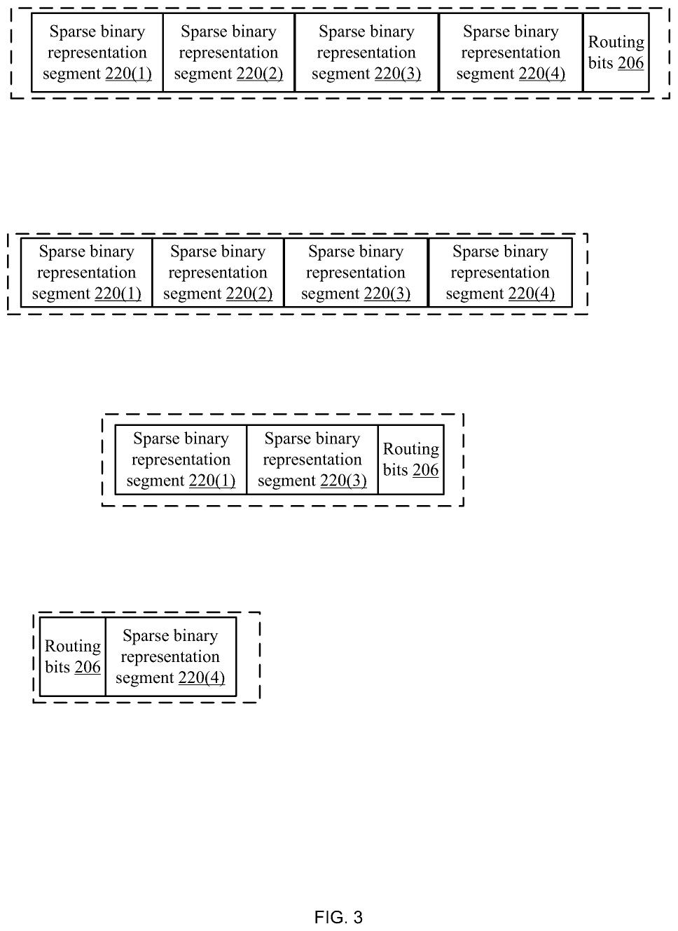

FIG. 3 illustrates examples of an output 222.

The first example includes a concatenation of all four SBRSs and the routing bits. The routing bits may be located in any position—for example at the start of the output (fourth example), at the end of the output 222 (first example) or an any other location.

The second example includes all four SBRSs and does not include the routing bits. This may save resources—especially when irrelevant SBRSs include values that are indicative that they are irrelevant.

The third example assumes that only the first and third SBRSs are relevant—and the output 222 consists of the first and third SBRSs and the routing bits.

The fourth example assumes that only fourth SBRS is relevant—and the output 222 consists of the fourth SBRS and the routing bits.

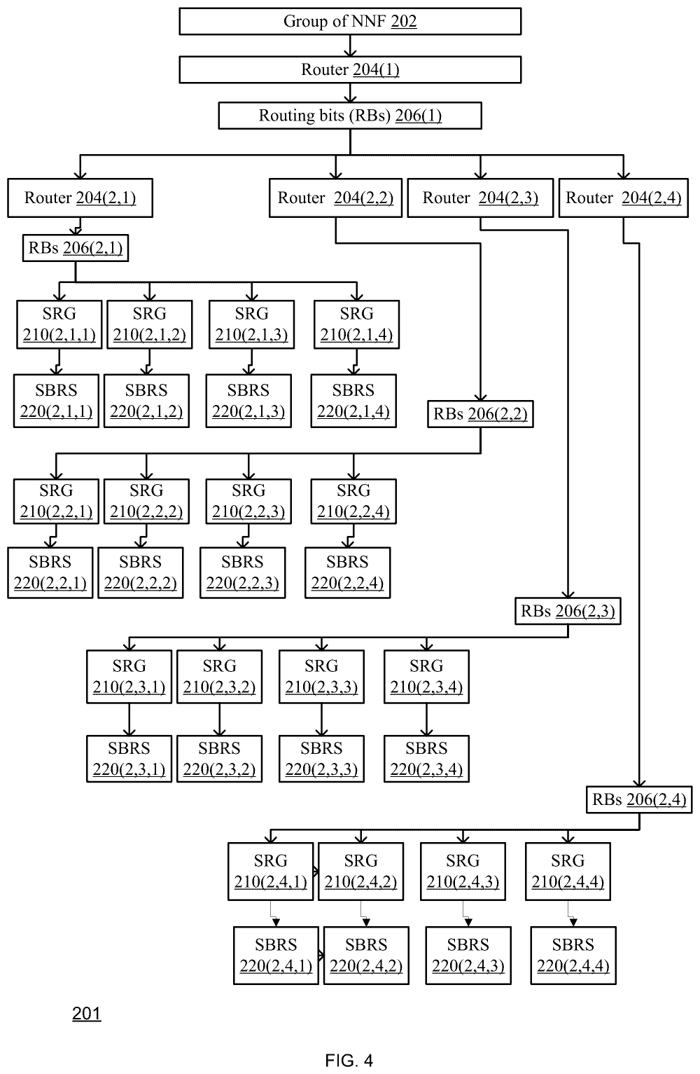

FIG. 4 illustrates an example of a system 201 that includes two level of routers, each router outputs four routing bits. There may be more than two levels and at least one of the router may include two, three or five or more routing bits.

The routers include a first level router 204(1), and four second level routers 204(2,1), 204(2,2), 204(2,3) and 204(2,4).

The set of SRGs include sixteen SRGs denoted 210(2,1,1)-210(2,1,4), 210(2,2,1)-210(2,2,4), 210(2,3,1)-210(2,3,4) and 210(2,4,1)-210(2,4,4). There may be any number of SRGs—between four and eleven, thirteen or more.

The sixteen SRGs may output up to sixteen SBRSs denoted 220(2,1,1)-220(2,1,4), 220(2,2,1)-220(2,2,4), 220(2,3,1)-220(2,3,4) and 220(2,4,1)-220(2,4,4).

The first level router 204(1) receives a group of NNFs 202 and determines which one or more second level routers are relevant. The first level router outputs first level routing bits 206(1) that are indicative of this determination.

Each one of the second level router may be relevant or not. A relevant second level router determines which SRGs associated with the second level router is relevant—and outputs second level routing bits (such as at least one of RBs 206(2,1), RBs 206(2,2), RBs 206(2,3) and RBs 206(2,4)).

The second level RBs are received by the SRGs that may output SBRSs, may output RBRSs only when relevant, may output irrelevant indicators when not relevant, and the like.

The output of the system may include any combination or sub-combination of routing bits from one or more levels, one or more SBRS, irrelevant indicators, and the like. Examples were provided in relation to FIG. 3.

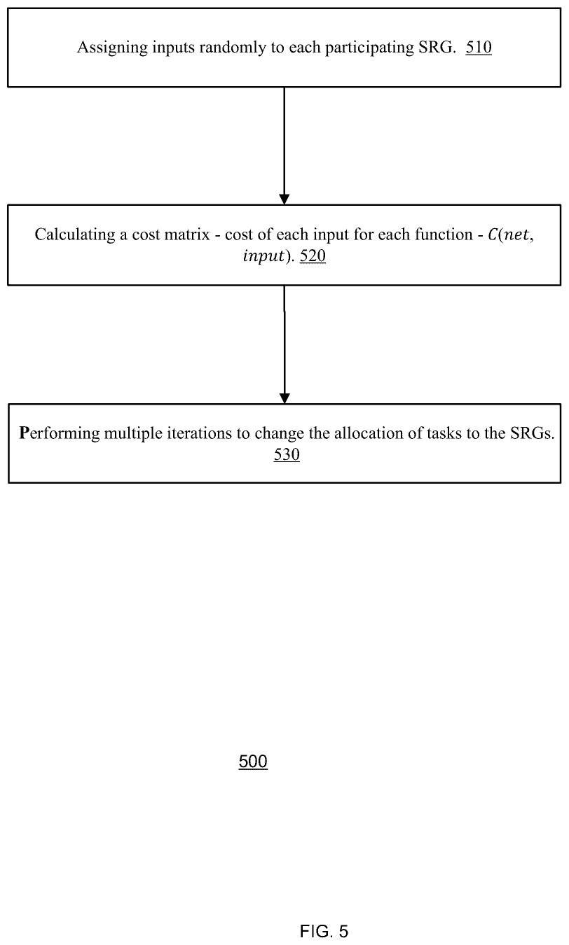

FIG. 5 illustrates an example of a first training process 500.

An example of a first training process of the SRGs allows the different SRGs to “trade” their inputs during training in order to enable specialization.

Inputs: Assignment matrix B(net, input), Neural networks net E {models}, Inputs input ∈X.

Outputs: New Assignment matrix B(net, input).

The first training process may start by step 510 of assigning inputs randomly to each participating SRG. The inputs may be SBRSs. Although the assignment of random, as the SRGs continue the learning they may start to diverge and differentiate from each other. They SRGs may react differently since they are effectively trained to overfit certain subset of the data. This implies they have error when applied to inappropriate data which is then allocated to a different SRG. It is expected that some of the SRGs will perform better on some inputs. The participating SRGs may perform during training the same task.

Step 510 may be followed by step 520 of calculating a cost matrix—cost of each input for each function—C(net, input).

Step 520 may be followed by step 530 of performing multiple iterations to change the allocation of tasks to the SRGs.

Step 530 may include repeating, for each SRG and until reaching a stop condition:
Evaluating (for example using a cost function) which task is the worst task (performance wise) allocated to a certain SRG.
Suggesting by the certain SRG to reallocate the worst task to another SRG.
Gathering offers from other SRGs to obtain (be allocated to) the worst task.
Selecting a reallocation that provides the best benefit to the certain SRG—or provides the best benefit to both parties (certain SRG and selected other SRG that will be allocated to perform the task).
Reallocating the worst task to the selected other SRG. This may include or may be followed by update the assignment matrix B(net, 1, seller)=0, B(net 1, buyer)=1 B(net 2, seller)=1, B(net 2, buyer)=0
Checking the stop condition—if not fulfilled then checking a new combination of SRG and worst task.

The stop condition may be fulfilled when there are no more reallocation to be done, when the benefit from reallocation is below a thresholds, when a predefined number of iterations was reached, and the like.

When completed—the assignment of tasks to SRGs may be expressed by an assignment matrix B(net, input) ∈ 0, 1, such that each input is assigned to one net only. The above algorithm may take a random assignment matrix and returns a new assignment matrix.

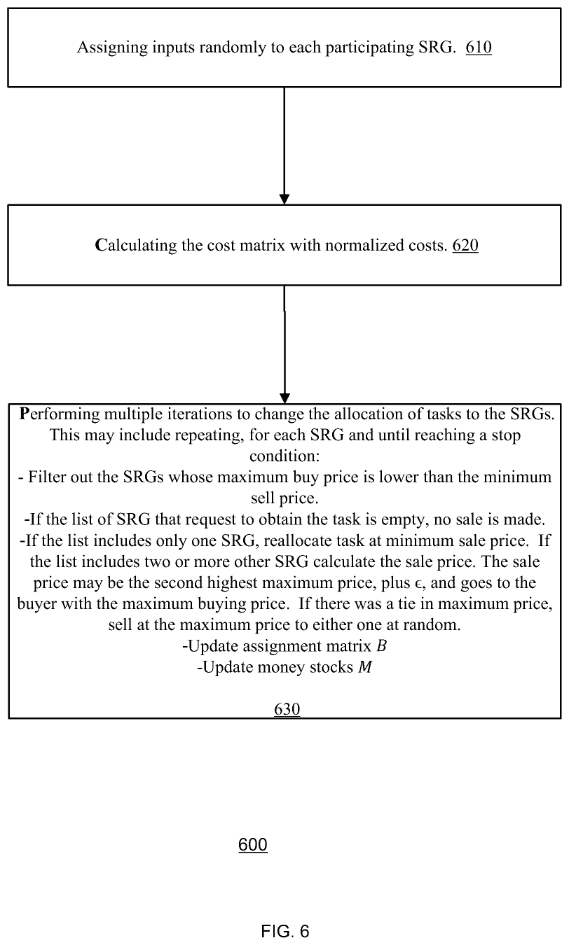

FIG. 6 illustrates an example of a second training process 600.

Let the normalized loss for function some network f for an input x be L f norm=(1−B(f, x)) max y L(f, y, t y\hat{ })+B(f, x) L(f, x, t x\hat{ }).

Let the minimum sale price be: P f min (x)=[max y C(y, f)]−C(x, f)+∈.

Let the maximum buy price: P f min (x)=min([max y C(y, f)]−C(x, f)−∈, Mf).

Let a monetary coin size ∈.

That is, the algorithm cannot spend more on purchases than his current amount of money, and only buys or sells if his total of L is increased. f norm−Mf

Inputs: Assignment matrix B(net, input), Money stocks M(net), Neural networks net ∈ {models}, Inputs input ∈X

Outputs: New Assignment matrix B(net, input).

The second training process 600 may start by step 610 of assigning inputs randomly to each participating SRG.

Step 610 may be followed by step 620 of calculating the cost matrix with normalized costs.

Step 620 may be followed by step 630 may include repeating, for each SRG and until reaching a stop condition (for example for all inputs in descending normalized cost order, until no further trade is possible)
Filter out the SRGs whose maximum buy price is lower than the minimum sell price.
If the list of SRG that request to obtain the task is empty, no sale is made. 1
If the list includes only one SRG, reallocate task at minimum sale price. If the list includes two or more other SRG calculate the sale price. The sale price may be the second highest maximum price, plus c, and goes to the buyer with the maximum buying price. If there was a tie in maximum price, sell at the maximum price to either one at random.
Update assignment matrix B
Update money stocks M

FIG. 7 illustrates an example of a system 700. System 700 may include one or more processors, each including one or more processing circuits. FIG. 7 illustrates the system as including processor 710 that includes processing circuit 712. The system may include one or more communication units. FIG. 7 illustrates system 700 as including bus 720 but other or additional types of communication units may be provided. The system 700 may include one or more memory units. FIG. 7 illustrates system 700 as including memory unit 730.

The memory unit is configured to store an operating system 741, neural network features 742, one or more relevant sparse outputs 744, lossless and sparse representations of the group of neural network features 746, router or allocation unit software 748, sparse representation generator software 750, communication unit software 752, routing bits 754, sparse binary representation segments 756, and any other data, metadata, software and the like required to execute the methods mentioned above.

The system is configured to execute any method of methods 100, 500 or 600.

The system is configured to implement any router illustrated above and/or any SEGs mentioned above and/or any unit or components illustrated above. For example—processor 710 may execute instructions and/or code and/or software and/or firmware to provide the functionality of the router and/or the functionality of the SEG, and the like.

According to an embodiment, memory unit 730 includes a volatile memory and/or a non-volatile memory. The memory unit 730 may be a random access memory (RAM) and/or a read only memory (ROM).

According to an embodiment, the non-volatile memory unit is a mass storage device, which can provide non-volatile storage of computer code, computer readable instructions, data structures, program modules, and other data for the processor or any other unit of vehicle. For example and not meant to be limiting, a mass storage device can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Any content may be stored in any part or any type of the memory unit.

According to an embodiment, the at least one memory unit stores at least one database—such as any database known in the art—such as DB2®, Microsoft® Access, Microsoft® SQL Server, Oracle®, mySQL, PostgreSQL, and the like.

The bus 720 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus, and all buses specified in this description can also be implemented over a wired or wireless network connection and each of the subsystems.

In the foregoing specification, the invention has been described with reference to specific examples of embodiments of the invention. It will, however, be evident that various modifications and changes may be made therein without departing from the broader spirit and scope of the invention as set forth in the appended claims. Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein. Furthermore, the terms “assert” or “set” and “negate” (or “deassert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one. Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality. Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality. Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments. Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner. However, other modifications, variations and alternatives are also possible. The specifications and drawings are, accordingly, to be regarded in an illustrative rather than in a restrictive sense. In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage. While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention. It is appreciated that various features of the embodiments of the disclosure which are, for clarity, described in the contexts of separate embodiments may also be provided in combination in a single embodiment. Conversely, various features of the embodiments of the disclosure which are, for brevity, described in the context of a single embodiment may also be provided separately or in any suitable sub-combination. It will be appreciated by persons skilled in the art that the embodiments of the disclosure are not limited by what has been particularly shown and described hereinabove. Rather the scope of the embodiments of the disclosure is defined by the appended claims and equivalents thereof.

What is claimed is:

1. A method for generating a sparse representation of a group of neural network features, the method comprises:
obtaining a group of neural network features; and
generating a lossless and sparse representation of the group of neural network feature, wherein the generating comprises:
determining, by an allocation unit and based on one or more attributes of the group of neural network features, one or more relevant sparse representation generators out of a set of relevant sparse representation generators;
generating, by the one or more relevant sparse representation generators, one or more relevant sparse outputs;
processing the one or more relevant sparse outputs to provide the lossless and sparse representation of the group of neural network features; and
outputting the lossless and sparse representation of the group of neural network features.

2. The method according to claim 1, wherein the allocation unit is a router.

3. The method according to claim 1, wherein different relevant sparse representation generators of the set are associated with different situations.

4. The method according to claim 1, wherein the processing is concatenating two or more relevant sparse outputs.

5. The method according to claim 1, wherein the lossless and sparse representation of the group of neural network features consists essentially of one or more outputs of the one or more relevant sparse representation generators and relevant sparse representation generator indicators that identify the one or more relevant sparse representation generators.

6. The method according to claim 5, wherein the relevant sparse representation generator indicators are routing bits.

7. The method according to claim 1, wherein the lossless and sparse representation of the group of neural network features comprises one or more outputs of the one or more relevant sparse representation generators and does not include any output of an irrelevant sparse representation generator.

8. The method according to claim 1, wherein the lossless and sparse representation of the group of neural network features comprises one or more outputs of the one or more relevant sparse representation generators and one or more outputs of one or more irrelevant sparse representation generator.

9. A non-transitory computer readable medium for generating a sparse representation of a group of neural network features, the non-transitory computer readable medium that stores instructions for:
obtaining a group of neural network features; and
generating a lossless and sparse representation of the group of neural network feature, wherein the generating comprises:
determining, by an allocation unit and based on one or more attributes of the group of neural network features, one or more relevant sparse representation generators out of a set of relevant sparse representation generators;
generating, by the one or more relevant sparse representation generators, one or more relevant sparse outputs;
processing the one or more relevant sparse outputs to provide the lossless and sparse representation of the group of neural network features; and
outputting the lossless and sparse representation of the group of neural network features.

10. The non-transitory computer readable medium according to claim 9, wherein the allocation unit is a router.

11. The non-transitory computer readable medium according to claim 9, wherein different relevant sparse representation generators of the set are associated with different situations.

12. The non-transitory computer readable medium according to claim 9, wherein the processing is concatenating two or more relevant sparse outputs.

13. The non-transitory computer readable medium according to claim 9, wherein the lossless and sparse representation of the group of neural network features consists essentially of one or more outputs of the one or more relevant sparse representation generators and relevant sparse representation generator indicators that identify the one or more relevant sparse representation generators.

14. The non-transitory computer readable medium according to claim 13, wherein the relevant sparse representation generator indicators are routing bits.

15. The non-transitory computer readable medium according to claim 9, wherein the lossless and sparse representation of the group of neural network features comprises one or more outputs of the one or more relevant sparse representation generators and does not include any output of an irrelevant sparse representation generator.

16. The non-transitory computer readable medium according to claim 9, wherein the lossless and sparse representation of the group of neural network features comprises one or more outputs of the one or more relevant sparse representation generators and one or more outputs of one or more irrelevant sparse representation generator.

17. The non-transitory computer readable medium according to claim 16, wherein a value of an output of an irrelevant sparse representation generator is indicative that the output was generated by an irrelevant sparse representation generator.

18. The non-transitory computer readable medium according to claim 9, wherein relevant sparse representation generators of the set of relevant sparse representation generators are arranged in a hierarchical manner.

19. The non-transitory computer readable medium according to claim 9 wherein at least one neural network feature is indicative of at least a part of a sensed information unit sensed by a sensor associated with a vehicle.

20. The non-transitory computer readable medium according to claim 9 wherein the lossless and sparse representation of the group of neural network features is indicative of at least a part of a sensed information unit sensed by a sensor associated with a vehicle.
